(19) United States
(12) Patent Application Publication
(10) Pub. No.: US 2025/0246725 A1
(43) Pub. Date: Jul. 31, 2025

(54) LITHIUM SECONDARY BATTERY

(71) Applicant: SK ON CO., LTD., Seoul (KR)

(72) Inventor: Ji Soo HAN, Daejeon (KR)

(21) Appl. No.: 19/019,495

(22) Filed: Jan. 14, 2025

(30) Foreign Application Priority Data
Jan. 29, 2024 (KR) 10-2024-0013504

(51) Int. Cl. H01M 50/112; H01M 10/0525; H01M 50/105; H01M 50/186

(52) U.S. Cl. CPC H01M 50/112; H01M 50/105; H01M 50/186; H01M 10/0525

(57) ABSTRACT

A lithium secondary battery is provided. The lithium secondary battery includes an electrode assembly accommodated inside a battery case. The battery case has two or more storage spaces separated by at least one partition wall, and each storage space accommodates at least one electrode assembly. The partition wall sequentially includes a first sealing layer, a first metal layer, and a second sealing layer.

### CROSS-REFERENCE TO RELATED APPLICATION(S)

This patent document claims the priority and benefits of Korean Patent Application No. 10-2024-0013504 filed on Jan. 29, 2024, the disclosure of which is incorporated herein by reference in its entirety.

### TECHNICAL FIELD

The disclosure and implementations disclosed in this patent document generally relate to a lithium secondary battery.

### BACKGROUND

In general, when it is desired to implement high voltage for a secondary battery, the voltage may be increased by connecting manufactured prismatic or pouch-type secondary batteries in series by an external circuit. In this case, the voltage increases by the number of secondary batteries in which battery cases such as pouch cases or aluminum cases of respective cells are connected in series, and thus, an energy density decreases by the thickness of the battery case.

Meanwhile, as another method for implementing the high voltage, a similar voltage may be implemented by directly connecting an electrode assembly inserted into the battery case in series inside the battery case. However, in this case, the voltage inside the battery case increases, causing a problem of decomposition of an electrolyte.

### SUMMARY

The present disclosure may be implemented in some embodiments to provide a secondary battery capable of implementing high voltage while providing high energy density.

The present disclosure may be implemented in some embodiments to provide a secondary battery capable of preventing decomposition of an electrolyte even when a high voltage is generated inside a battery case.

A secondary battery in the present disclosure may be widely applied in green technology fields such as electric vehicles, battery charging stations, and solar power generation and wind power generation using batteries. In addition, a secondary battery some embodiments of the present disclosure may be used in eco-friendly electric vehicles, hybrid vehicles, and the like to ameliorate the effects of climate change by suppressing air pollution and greenhouse gas emissions.

In some embodiments of the present disclosure, a lithium secondary battery includes an electrode assembly accommodated inside a battery case. The battery case has two or more storage spaces separated by at least one partition wall, and each storage space accommodates at least one electrode assembly. The partition wall sequentially includes a first sealing layer, a first metal layer, and a second sealing layer.

The battery case may include an upper case and a lower case, and the upper case and the lower case may include an inner sealing layer, a second metal layer, and an outer resin layer.

The battery case may have an inner sealing layer of the upper case and an inner sealing layer of the lower case, facing each other, and a partition wall interposed between the two inner sealing layers.

The battery case may include an upper case and a lower case, the battery case may include a sealing portion to which the upper case and the lower case are attached on an edge of the battery case, and the sealing portion may include at least three metal layers.

The sealing portion may be provided on the same surface as a surface on which two adjacent electrode assemblies meet.

The sealing portion may have a step from a surface on which two adjacent electrode assemblies meet.

The partition wall may be formed to have a step between the sealing portion and the surface on which the two adjacent electrode assemblies meet.

The battery case may include the sealing portion on four sides.

The battery case may be a single sheet in which the upper case and the lower case are connected, and may include a connecting sealing portion formed in a position in which the upper case and the lower case are connected.

The connecting sealing portion may have a folding line folded at an end, and may include a margin between the folding line and the storage space.

The battery case may be a separate sheet in which the upper case and the lower case are separated.

The battery case may include the sealing portion on three sides.

The battery case may be a single sheet in which the upper case and the lower case are connected, and may include a connecting sealing portion formed in a position in which the upper case and the lower case are connected.

A thickness of the partition wall, T (partition), may satisfy Expression (1): T (battery case)<T (partition)<2×T (battery case), and in the expression (1), T (partition) is the thickness of the partition wall, and T (battery case) is a thickness of the battery case.

The first sealing layer and the second sealing layer may be formed of a material selected from the group consisting of polypropylene (PP) and polyethylene (PE).

The first metal layer may be formed of a material selected from the group consisting of aluminum (Al); copper (Cu); an alloy of iron (Fe), carbon (C), chromium (Cr), and manganese (Mn); an alloy of iron (Fe), carbon (C), chromium (Cr), and nickel (Ni); and at least one of iron (Fe), carbon (C), chromium (Cr), manganese (Mn), copper (Cu) and nickel (Ni), and an alloy including aluminum (Al).

The lithium secondary battery may further include an inner resin layer on at least one surface of the first metal layer.

The inner resin layer may be formed of a material selected from the group consisting of nylon, polyethylene, polypropylene, polyethylene terephthalate, low-density polyethylene, and high-density polyethylene.

A first electrode assembly stored in a first storage space separated by the partition wall and a second electrode assembly stored in a second storage space may be electrically connected in series.

### BRIEF DESCRIPTION OF DRAWINGS

Certain aspects, features, and advantages of the present disclosure are illustrated by the following detailed description with reference to the accompanying drawings.

FIG. 1 is a perspective view schematically illustrating a secondary battery according to an embodiment.

FIG. 2 is a diagram schematically illustrating a cross-section of a battery case according to an embodiment.

FIG. 3 is a diagram schematically illustrating an example of storing two electrode assemblies in one battery case.

FIG. 4 is a cross-sectional view illustrating a cross-section of a partition wall according to an embodiment by way of example.

FIG. 5 is a diagram schematically illustrating a cross-section of a secondary battery before sealing according to an embodiment, and is a cross-sectional view corresponding to a cross-section cut in the I-I′ direction of FIG. 1.

FIG. 6 is a diagram schematically illustrating a cross-section of a secondary battery before sealing according to another embodiment, and is a cross-section corresponding to a cross-section cut in the I-I′ direction of FIG. 1.

FIG. 7 is a cross-sectional view schematically illustrating an example of a secondary battery manufactured by sealing the secondary battery of FIG. 5.

FIG. 8 is a cross-sectional view illustrating another example of a secondary battery manufactured by sealing the secondary battery of FIG. 5, and schematically illustrates an example in which one end of a partition wall is attached to an inside of a battery case.

FIG. 9 is a cross-sectional view schematically illustrating an example of a secondary battery in which a battery case is a sheet in which an upper case and a lower case are connected, and a sealing portion is formed on four sides.

FIG. 10 is a cross-sectional view schematically illustrating an example of a secondary battery in which a battery case is a sheet in which an upper case and a lower case are separated, and a sealing portion is formed on four sides.

FIG. 11 is a cross-sectional view schematically illustrating an example of a secondary battery in which a position of a boundary surface of two electrode assemblies and a position of a surface on which a sealing portion is formed do not match, resulting in a step.

FIG. 12 is a cross-sectional view schematically illustrating an example of electrically connecting two secondary batteries.

FIG. 13 is a cross-sectional view schematically illustrating an example of a secondary battery in which two electrode assemblies separated by a partition wall are housed in one battery case, and the two electrode assemblies are electrically connected.

FIG. 14 is a cross-sectional view schematically illustrating an example of a secondary battery in which two electrode assemblies are housed in one battery case and two electrode assemblies are electrically connected.

### DETAILED DESCRIPTION

Features of the present disclosure disclosed in this patent document are described by example embodiments with reference to the accompanying drawings.

Hereinafter, the present disclosure will be described in detail with reference to the attached drawings. However, this is merely illustrative and the present disclosure is not limited to the detailed embodiments described as examples.

In the present disclosure, a secondary battery may refer to a lithium secondary battery.

A secondary battery provided in the present disclosure is a lithium secondary battery in which an electrode assembly is stored inside a battery case. The battery case has two or more storage spaces separated by at least one partition wall, each storage space stores at least one electrode assembly, and the partition wall sequentially includes a first sealing layer, a first metal layer, and a second sealing layer.

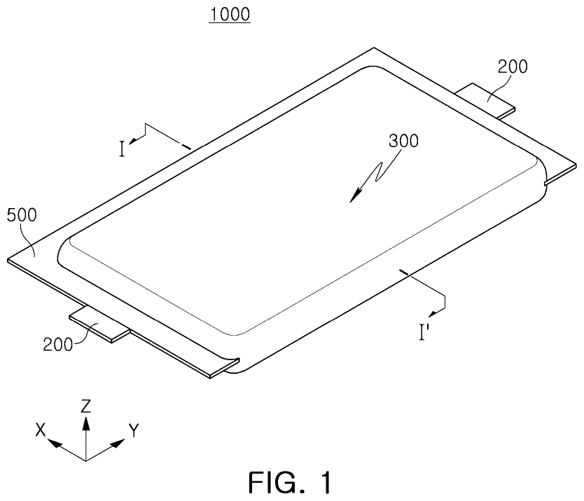

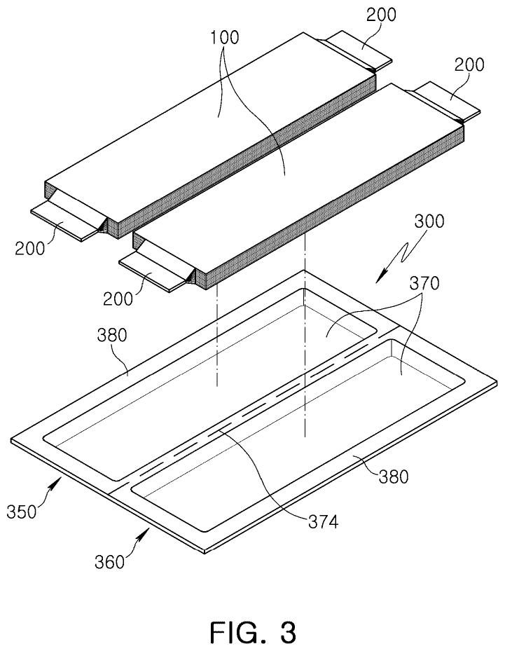

A secondary battery according to an example embodiment is schematically illustrated in FIG. 1, and an example of storing two electrode assemblies in one battery case is schematically illustrated in FIG. 3. FIG. 1 is a perspective view schematically illustrating the external appearance of a pouch-type secondary battery 1000. As an example, referring to FIG. 3, an electrode assembly 100 is housed in a battery case 300 including an upper case 350 and a lower case 360, and after the upper case 350 and the lower case 360 of the battery case 300 are overlapped, at least a portion of an edge 380 of the battery case 300 is sealed, an electrolyte is filled inside the battery case 300, and the edge 380 of the battery case 300 is completely sealed, thereby manufacturing a secondary battery 1000. The manufactured secondary battery 1000 may have the exterior of a pouch-type secondary battery 1000 illustrated in FIG. 1. Before the electrolyte is filled into the battery case 300, sealing at least a portion of the edge 380 of the battery case 300 may mean sealing a portion of the edge 380 of the battery case 300 to the extent that the electrolyte does not flow out when the electrolyte is filled into the battery case 300, and for example, sealing may be performed on one side, two sides, or three sides where the upper case and the lower case are adjacent.

The secondary battery 1000 manufactured thereby has a sealing portion 500 on a plane perpendicular to the Z axis (X-Y plane) as illustrated in FIG. 1, and the sealing portion 500 is not particularly limited, but may be formed on three sides where the upper case and the lower case are adjacent, excluding an edge portion where a folding line 374 is provided among the edges where the upper case and the lower case of the battery case 300 may overlap and come into contact, as illustrated in FIG. 1 and FIG. 3 (referred to as a three-sided sealing portion in the present disclosure). Alternatively, the sealing portion 500 may be formed on four sides where the upper case and the lower case are adjacent at the edge of the battery case 300 (referred to as a four-sided sealing portion in the present disclosure).

In addition, cathode and anode tabs 200 are led out to the outside of the battery case 300 through the sealing portion 500, and respective electrode tabs 200 may be led out through the sealing portion 500 of one side, and respective electrode tabs 200 may be led out through the sealing portion 500 of two sides as illustrated in FIG. 1.

In the present disclosure, the battery case may be a prismatic battery case formed of a metal such as aluminum, and may be a pouch-type battery case formed of a laminate sheet including a metal foil.

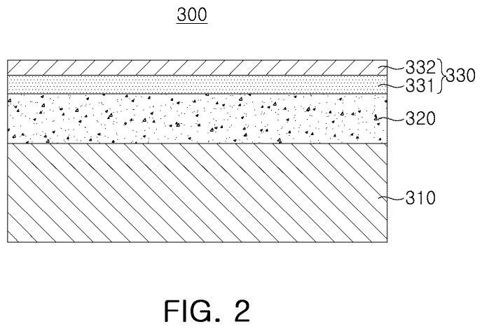

The pouch-type battery case 300 may be, but is not limited to, a laminate sheet as schematically illustrated in FIG. 2. In detail, the pouch-type battery case 300 may sequentially include, for example, an inner sealing layer 310, a second metal layer 320, and an outer resin layer 330. Hereinafter, an embodiment will be described with the pouch-type battery case 300 as the center.

The inner sealing layer 310 is a layer located at the innermost side of the pouch-type battery case 300, has chemical resistance to electrolyte and heat adhesiveness, and serves as a sealing material, and may be mainly formed of a polyolefin-based resin. The polyolefin resin may include, for example, polyethylene (PE), polypropylene (PP), or a copolymer thereof.

The inner sealing layer 310 may have a thickness of, for example, 20 to 100 μm, but is not limited thereto.

The second metal layer 320 is a layer interposed between the inner sealing layer 310 and the outer resin layer 330, and provides mechanical strength to the pouch-type battery case 300 and acts as a barrier against moisture and oxygen. The second metal layer 320 may be, but is not limited to, a foil formed of aluminum (Al); copper (Cu); an alloy of iron (Fe), carbon (C), chromium (Cr), and manganese (Mn); an alloy of iron (Fe), carbon (C), chromium (Cr), and nickel (Ni); or an alloy including at least one of iron (Fe), carbon (C), chromium (Cr), manganese (Mn), copper (Cu) and nickel (Ni), and aluminum (Al), and, in detail, may be an aluminum (Al) foil.

The second metal layer 320 may have a thickness of, but is not limited to, for example, 30 to 100 μm.

The outer resin layer 330 is a layer formed on the outermost side of the pouch-type battery case 300, and serves to protect the battery from external impact, and since the outer resin layer 330 comes into direct contact with hardware, insulation, heat resistance or the like is required. The outer resin layer 330 may be, but is not limited thereto, a single layer of at least one type or a composite layer of two or more types selected from the group consisting of terephthalate (PET), nylon, low-density polyethylene (LDPE), and high-density polyethylene (HDPE). For example, the outer resin layer 330 may be a single layer of PET, and may be a composite layer including an inner layer 331 of nylon and an outer layer 332 of PET on the second metal layer 320.

The outer resin layer 330 may have a thickness of, for example, but is not limited thereto, 20 to 50 μm. In addition, when the outer resin layer 330 includes the inner layer 331 and the outer layer 332, the inner layer 331 and the outer layer 332 may have a thickness ratio of 1:1 to 3:1 within the thickness range of the outer resin layer 330.

The electrode assembly 100 is stored in the pouch-type battery case 300. An example of a battery case 300 having the storage space 370 and the electrode assembly 100 being seated in the storage space 370 is schematically illustrated in FIG. 3.

As illustrated in FIG. 3, the pouch-type battery case 300 includes an upper case 350 and a lower case 360, and the upper case 350 and/or the lower case 360 may have a storage space 370 formed in a predetermined shape so that an electrode assembly 100 may be stored therein. The storage space 370 may be formed in both the upper case 350 and the lower case 360.

In the present disclosure, ‘A, B and/or C’ represent any one of the described examples or a combination of two or more, and represent the meaning of ‘at least one/a type selected from the group consisting of A, B and C’.

After each electrode assembly 100 or a plurality of electrode assemblies 100 having a predetermined thickness are disposed in the storage space 370 formed in the upper case 350 and/or the lower case 360, the upper case 350 and the lower case 360 are folded along the folding line 374 to overlap each other, and a folded edge 380 is sealed, thereby manufacturing a secondary battery 1000.

As an example embodiment, the depth of the storage space 370 formed in each of the upper case 350 and/or the lower case 360 may be determined according to the thickness of the electrode assembly 100 to be stored. For example, the sum of the depths of the storage spaces 370 formed in the upper case 350 and the lower case 360, respectively, may be equal to or greater than the sum of the thicknesses of two or more electrode assemblies 100 to be stored in the storage spaces 370, respectively. At this time, the depth of the storage space 370 formed in the upper case 350 and the depth of the storage space 370 formed in the lower case 360 may be equal to or different from each other, and the storage space 370 may be formed in only one of the upper case 350 and the lower case 360.

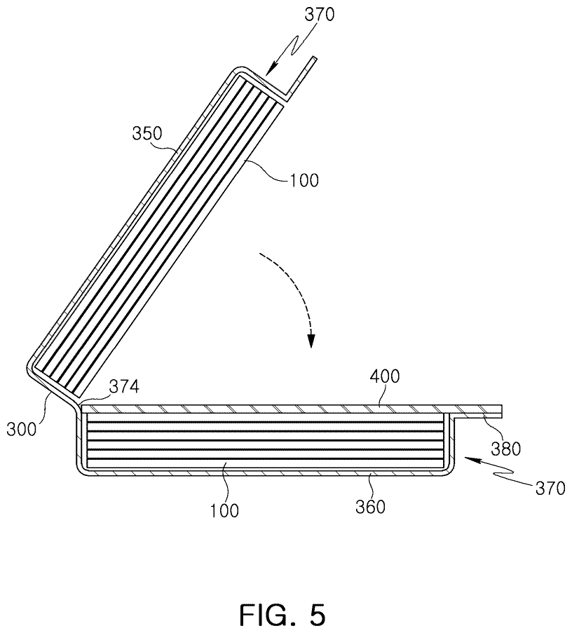

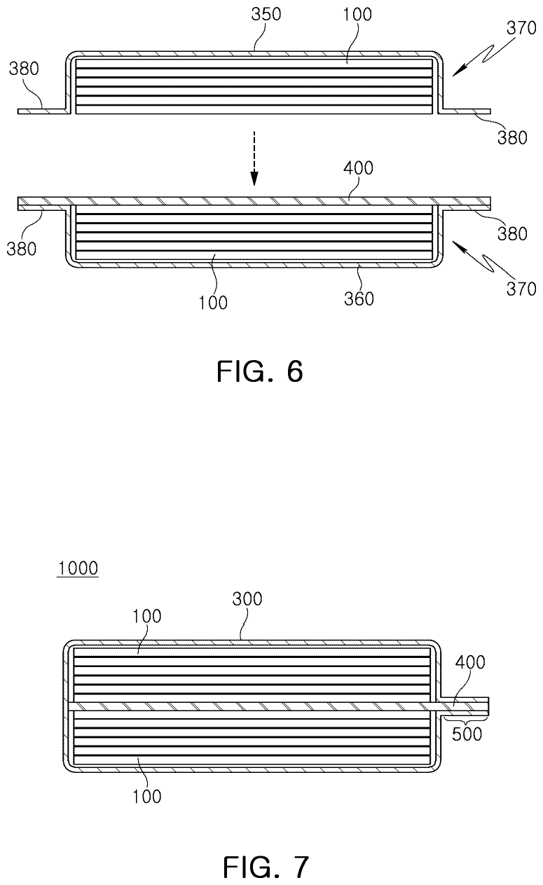

The shapes of the upper case 350 and the lower case 360 constituting the battery case 300 according to an example embodiment are illustrated in FIGS. 5 and 6 by way of example. FIGS. 5 and 6 are exploded cross-sectional views corresponding to the cross-section of the secondary battery 1000 cut in the I-I′ direction of FIG. 1. (In this specification, the cross-sectional view is a cross-sectional view illustrating the cross-section in the I-I′ direction of FIG. 1 unless otherwise described.)

In the present disclosure, as illustrated in FIG. 5, the upper case 350 and the lower case 360 may be one sheet connected to each other. Also, as illustrated in FIG. 6, the upper case 350 and the lower case 360 may be separate sheets separated from each other. In this case, the connected sheet or one connected sheet is distinguished from a sheet that is connected afterward by a method such as bonding separate sheets, or the like.

As illustrated in the drawings 5 and 6, the electrode assembly 100 is seated in the storage space 370 of the upper case 350 and/or the lower case 360, and the upper case 350 and the lower case 360 overlap and are sealed as indicated by the dotted arrows, thereby manufacturing a secondary battery 1000 having a sealing portion 500.

The sealing portion 500 in which the upper case 350 and the lower case 360 are sealed is formed in a direction perpendicular to the Z-axis corresponding to the thickness of the secondary battery 1000 in the XYZ coordinates illustrated in FIG. 1, and may have a surface parallel to the X-Y plane.

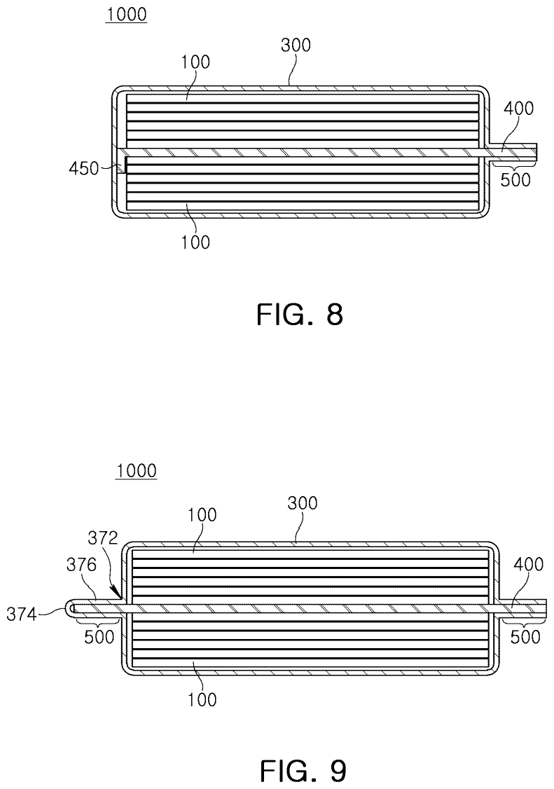

The secondary battery 1000 manufactured using the battery case 300 of the drawing 5 is schematically illustrated in, for example, FIG. 7, FIG. 8, or FIG. 9. In detail, the secondary battery 1000 illustrated in FIGS. 7 to 9 is an example manufactured using a sheet in which an upper case 350 and a lower case 360 are connected to each other as a battery case 300. As illustrated in FIGS. 7 and 8, the sealing portion 500 may be formed on three sides of the secondary battery 1000, and a connecting sealing portion may be formed on the remaining side where the upper case and the lower case are connected to each other. In addition, as illustrated in FIG. 9, the sealing portion 500 may be formed on four sides of the secondary battery 1000, and the sealing portion may include a connecting sealing portion formed in a position in which the upper case and the lower case are connected.

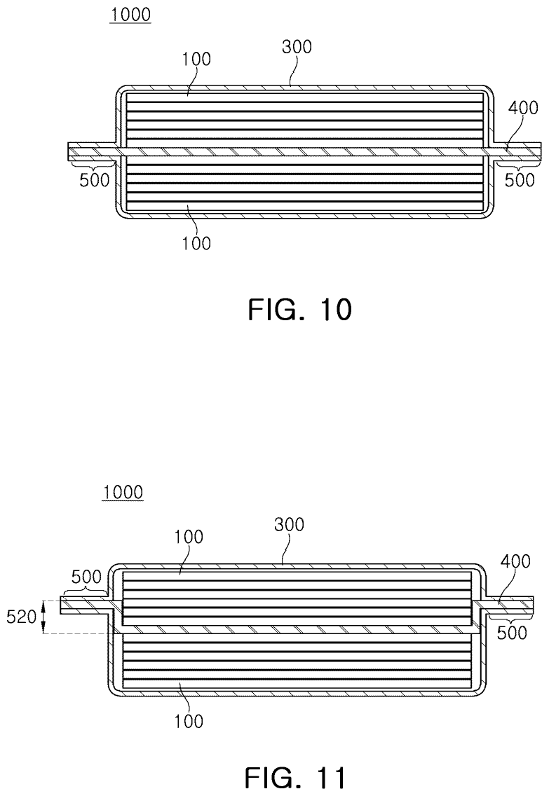

In addition, an example of a secondary battery 1000 manufactured using the battery case 300 of FIG. 6 is schematically illustrated in FIG. 10 and FIG. 11, and in detail, the battery case 300 may be manufactured using separate sheets in which the upper case 350 and the lower case 360 are separated, and in this case, a sealing portion 500 may be formed on four sides of the secondary battery 1000.

The sealing portion 500 may be formed at various positions with respect to the plane in the Z-axis direction. FIG. 7 to FIG. 11 illustratively show the position of the sealing portion 500 in the secondary battery 1000 provided in the present disclosure observed in the I-I′ cross-section of FIG. 1. The position of the sealing portion 500 may vary depending on the depth of the storage space 370 formed in the upper case 350 and/or the lower case 360.

For example, when the depths of the storage spaces 370 formed in the upper case 350 and the lower case 360 are the same, as illustrated in FIGS. 7 to 10, the sealing portion 500 may be positioned parallel to the X-Y plane, on the center line of the thickness of the surface in the Z-axis direction.

Meanwhile, when the depths of the storage spaces 370 formed in the upper case 350 and the lower case 360 are different, as illustrated in FIG. 11, the sealing portion 500 may be positioned apart from the center line of the thickness of the surface in the Z-axis direction. For example, the sealing portion 500 may be positioned parallel to the X-Y plane by being tilted upward or downward based on the center line of the thickness, and in some cases, may be positioned on the same surface as the surface of the secondary battery 1000. FIG. 11 illustrates an example using the battery case 300 illustrated in FIG. 6, but may also be applied to the case using the battery case 300 of FIG. 5.

The sealing portion 500 may be folded or rolled (or wound) to reduce the volume occupied by the secondary battery 1000, and may be brought close to or in close contact with the main body of the secondary battery 1000. For example, when the sealing portion 500 is folded, the folding may be at 90 degrees, and performed once, twice, three times, four times, or more.

The secondary battery 1000 may include a partition wall 400 between the plurality of electrode assemblies 100 housed inside the battery case 300 so that the plurality of electrode assemblies 100 are isolated from each other.

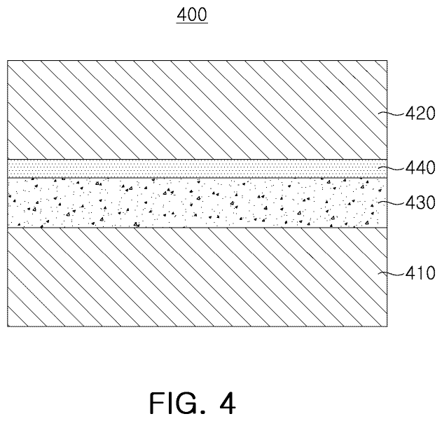

A cross-section of the partition wall 400 is schematically illustrated in FIG. 4. As illustrated in FIG. 4, the partition wall 400 may be a laminated sheet including a first sealing layer 410 and a second sealing layer 420 on both sides, and a first metal layer 430 between the first and second sealing layers 410 and 420, and may further include an inner resin layer 440 between the sealing layers 410 and 420 and the first metal layer 430 as needed. The partition wall 400 according to an example embodiment may have, for example, a structure of a first sealing layer 410, a first metal layer 430, and a second sealing layer 420 in sequence, and may have a first sealing layer 410, a first metal layer 430, an inner resin layer 440, and a second sealing layer 420.

The first sealing layer 410 and the second sealing layer 420 are layers located at the outermost side of the partition wall 400 and are positioned between the electrode assemblies 100 within the battery case 300 to isolate the electrode assemblies from each other, and are sealed by heat with the inner sealing layer 310 of the pouch-type battery case 300, and are required to have chemical resistance to the electrolyte and thermal adhesiveness, and further, electrical insulation. Therefore, the first sealing layer 410 and the second sealing layer 420 may be formed of a polyolefin series resin, like the inner sealing layer 310 of the pouch-type battery case 300. Examples of the polyolefin series resin include polyethylene (PE), polypropylene (PP), or a copolymer thereof.

The thicknesses of the first sealing layer 410 and the second sealing layer 420 may be the same as each other or may be different from each other, and are not limited thereto, but may each have a thickness of, for example, 20 to 100 μm.

The first metal layer 430 may provide mechanical strength to the partition wall 400 and may block the movement of the electrolyte between the two storage spaces 370 separated by the partition wall 400, thereby separating the operating environment of respective cells. The first metal layer 430 may be a foil formed of, but is not limited thereto, aluminum (Al); copper (Cu); an alloy of iron (Fe), carbon (C), chromium (Cr), and manganese (Mn); an alloy of iron (Fe), carbon (C), chromium (Cr), and nickel (Ni); or an alloy including at least one of iron (Fe), carbon (C), chromium (Cr), manganese (Mn), copper (Cu), and nickel (Ni) and aluminum (Al), and in detail, may be an aluminum (Al) foil.

The first metal layer 430 may have, but is not limited to, a thickness of, for example, 30 to 100 μm.

The partition wall 400 of the present disclosure may further include an inner resin layer on at least one surface of the first metal layer, if necessary, and may include, for example, an inner resin layer 440 between the first sealing layer 410 and the first metal layer 430 and/or the second sealing layer 420 and the first metal layer 430. For example, referring to FIG. 4, an inner resin layer 440 may be provided between the second sealing layer 420 and the first metal layer 430, and the inner resin layer 440 may improve insulation properties for the first metal layer. The inner resin layer 440 above is not limited thereto, but may be formed of a material selected from the group consisting of terephthalate (PET), nylon (Nylon), low-density polyethylene (LDPE), and high-density polyethylene (HDPE). For example, the inner resin layer 440 may be nylon.

The inner resin layer 440 is not limited thereto, but may have a thickness of, for example, 10 to 30 μm.

Although not particularly limited, in the partition wall 400, the first sealing layer 410 and/or the second sealing layer 420 and the inner resin layer 440 may be formed of the same or different materials.

As illustrated in FIGS. 5 and 6, the partition wall 400 is disposed between a plurality of electrode assemblies 100 housed in a pouch-type battery case 300, and two adjacent electrode assemblies 100 are isolated by the partition wall 400. Meanwhile, the partition wall 400 may be interposed between the upper and lower cases 350 and 360 and sealed together when the upper and lower cases 350 and 360 overlap and the edge 380 of the battery case 300 is sealed, thereby dividing the inside of the battery case 300 by the partition wall 400 and preventing movement of the electrolyte. In addition, for example, the storage space 370 formed inside the upper case 350 may be referred to as a first storage space or a second storage space, and in distinction therefrom, the storage space 370 formed inside the lower case 360 may be referred to as a second storage space or a first storage space.

As described above, by including a partition wall 400 that isolates the electrode assemblies 100 inside the battery case 300, even if a high voltage is implemented in one secondary battery, decomposition of the electrolyte inside the battery may be prevented or suppressed, thereby promoting a long life of the battery.

The secondary battery 1000 provided in the present disclosure includes a battery case 300 including an upper case 350 and a lower case 360, and a sealing portion 500 in which the upper case 350 and the lower case 360 are attached, at an edge 380 of the battery case 300, and the sealing portion 500 includes a partition wall 400 between the upper case 350 and the lower case 360.

In more detail, the sealing portion 500 of the secondary battery 1000 according to an example embodiment may have an inner sealing layer 310 of the upper case 350 and an inner sealing layer 310 of the lower case 360 facing each other, and a partition wall 400 positioned between the two inner sealing layers. In addition, the sealing portion 500 may include at least three metal layers, by including an upper case 350, a lower case 360, and a partition wall 400.

As illustrated in FIGS. 5 and 6, the partition wall 400 is disposed between a plurality of electrode assemblies 100 housed in the battery case 300, for example, at a boundary surface between two electrode assemblies 100, and the sealing portion 500 may be formed by sealing the edge of the partition wall 400 together with the edge 380 of the upper and lower cases 350 and 360.

At this time, the sealing portion 500 including the partition wall 400 may be positioned on the same surface as the boundary surface where two adjacent electrode assemblies with the partition wall 400 positioned therewith face each other. For example, as illustrated in FIGS. 5 and 6, by adjusting the depth of the storage space 370 according to the thickness of each electrode assembly 100 stored in the upper and lower cases 350 and 360, the sealing portion 500 may be formed on the same surface as the boundary surface of the two electrode assemblies 100.

FIGS. 7 to 10 are cross-sections of a secondary battery 1000 corresponding to the I-I′ cross-section of FIG. 1, and illustrate examples of secondary batteries in which the sealing portion 500 is formed on the same surface as the boundary surface between the two electrode assemblies 100 where the partition wall 400 is located.

As another example, the sealing portion 500 having the partition wall 400 may have a step 520 from the boundary surface where the two adjacent electrode assemblies 100 meet. For example, as illustrated in FIG. 11, in the case of using a battery case 300 in which the storage spaces 370 having a different depth different from the thickness of the electrode assemblies 100 accommodated in the upper and lower cases 350 and 360 are formed, the surface where the two electrode assemblies 100 meet and the surface where the sealing portion 500 is formed may not match each other, and thus a step 520 may be formed between the two surfaces.

In the case where the step 520 is formed as above, as illustrated in FIG. 11, the partition wall 400 inserted between the two electrode assemblies 100 may be formed into a predetermined shape and disposed to have a step 520 as much as the surface where the partition wall is provided and the surface where the sealing portion 500 is provided do not match each other. By including the partition wall 400 in this manner, the position of the sealing portion 500 may be arbitrarily adjusted, and the sealing portion 500 may be formed on the same surface as the surface of the secondary battery 1000.

The forming of the partition wall 400 may be performed by a person skilled in the art by a method of forming a pouch-type battery case 300, and is not specifically described herein.

A secondary battery 1000 having a partition wall 400 according to an embodiment may include a sealing portion 500 on three or four sides of the battery case 300.

First, as an example of the secondary battery 1000 having a three-sided sealing portion 500, if the battery case 300 is a sheet in which an upper case 350 and a lower case 360 are connected, as illustrated in FIG. 5, the electrode assembly 100 is isolated by a partition wall 400, the upper case 350 and the lower case 360 are folded along a folding line 374 to allow the upper case 350 and the lower case 360 to overlap each other, and the partition wall 400 is interposed between the edges 380 of the upper and lower cases 350 and 360 to seal the three sides, thereby manufacturing a secondary battery 1000 having a three-sided sealing portion 500 as illustrated in FIG. 7.

Meanwhile, on one side other than the three sides where the sealing portion 500 is formed, one end 450 of the partition wall 400 may be sealed or bonded to the inside of the battery case 300 to isolate the electrode assembly 100 inserted into the battery case 300. For example, as illustrated in FIG. 8, the end 450 of the partition wall 400 may be sealed with a portion of the inner sealing layer 310 of the inside of the battery case 300 or bonded to a portion of the inner sealing layer 310. In sealing or bonding the end 450 of the partition wall 400 and a portion of the inner sealing layer 310 of the battery case 300, the end 450 of the partition wall 400 may be formed into a predetermined shape as described above to be sealed with the inner sealing layer 310 inside the battery case 300, and may be bonded using an adhesive or the like.

As an example of a secondary battery 1000 having a four-sided sealing portion 500, if the battery case 300 is a sheet in which the upper case 350 and the lower case 360 are connected, a secondary battery 1000 having a four-sided sealing portion 500 may be manufactured. A cross-section of a secondary battery 1000 having a four-sided sealing portion 500 is schematically illustrated in FIG. 9. As illustrated in FIG. 9, a margin 376 is provided between a folding line 374 formed when the upper case 350 and the lower case 360 are folded, and a start position 372 of the storage space 370 formed in the upper case 350 and/or the lower case 360. The upper case 350, the partition wall 400, and the lower case 360 may be sealed in the margin 376, and thereby a secondary battery 1000 having a four-sided sealing portion 500 as illustrated in FIG. 9 may be manufactured. Accordingly, the secondary battery 1000 in FIG. 9 includes a connecting sealing portion formed in a position in which the upper case 350 and the lower case 360 are connected in the four sealing portions 500, and the upper case and the lower case may be folded at the end of the connecting sealing portion, and a folding line may be included at the end of the connecting sealing portion.

As another embodiment of a secondary battery 1000 having a four-sided sealing portion 500, in the case in which the battery case 300 is a separate sheet in which the upper case 350 and the lower case 360 are separated from each other, as illustrated in FIG. 6, the upper and lower cases 350 and 360 overlap, and a partition wall 400 is interposed between the upper and lower cases 350 and 360, to be sealed, thereby manufacturing a secondary battery 1000 having a four-sided sealing portion 500 as illustrated in FIG. 10 or FIG. 11.

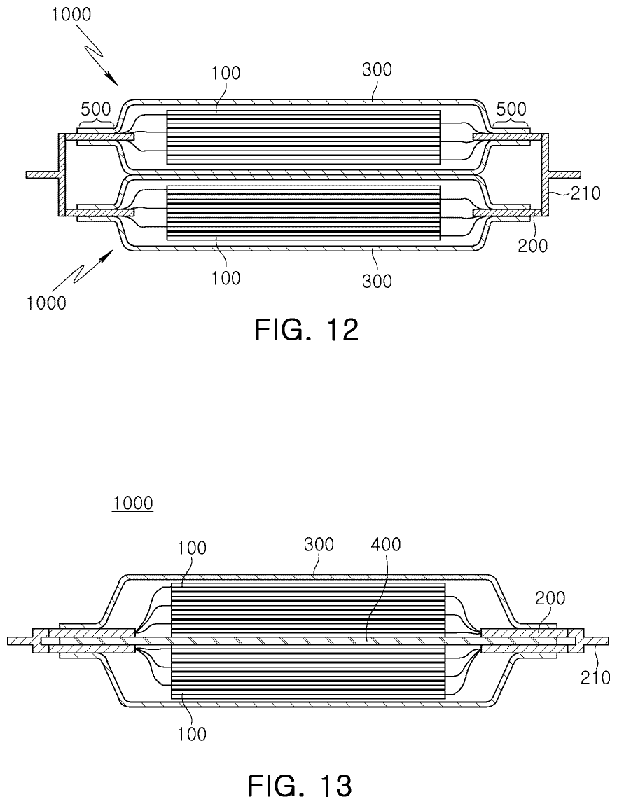

Generally, two or more secondary batteries may be connected in series or in parallel with an electrical connection unit 200, and the voltage may be increased by connection in series. An example of electrically connecting two secondary batteries is schematically illustrated in FIG. 12. FIG. 12 is a cross-sectional view of a secondary battery 1000 in which cathode and anode tabs 200 are led out on both sides of a battery case 300, respectively, and illustrates the cross-section in the direction in which the two electrode tabs 200 are led out.

As illustrated in FIG. 12, two secondary batteries 1000 may be connected in series by an electrical connection unit 210. For example, the two secondary batteries 1000 may be electrically connected in series by welding the cathode and the anode using an electrical connection unit such as an external conductor, thereby implementing a high voltage battery. However, at the interface where the two secondary batteries 1000 come into contact, the battery cases 300 provided from the respective secondary batteries 1000 overlap, resulting in an increase in thickness by the thickness of the battery cases 300, which ultimately leads to a decrease in energy density. This decrease in energy density may be more significant in a pack and/or module unit including a plurality of secondary batteries.

For example, in the secondary battery 1000 of FIG. 12, if the sheet thickness of the battery case 300 is 153 μm (including the inner sealing layer 310 of PP of 80 μm, the second metal layer 320 of Al of 40 μm, the outer resin layer 330 including the inner layer 331 of nylon of 15 μm and the outer layer 332 of PET of 12 μm, other adhesives, and the like), since there are two battery cases 300, the total thickness of the part that cannot store energy between the electrode assemblies 100 in the two secondary batteries 1000 is 306 μm.

However, in the secondary battery 1000 according to an embodiment of the present disclosure, as an example, two electrode assemblies 100 housed in one battery case 300 may be isolated by one partition wall 400 and electrically connected by an electrical connection unit 210. In this manner, in the secondary battery 1000 according to an example embodiment of the present disclosure, the thickness of a component that cannot store energy may be reduced compared to the case where two secondary batteries 1000 are electrically connected as illustrated in FIG. 12.

For example, the secondary battery 1000 according to an embodiment is schematically illustrated in FIG. 13. FIG. 13 is a cross-sectional view illustrating a cross-section of a secondary battery 1000 in which cathode and anode tabs 200 are respectively led out on both sides of a battery case 300, and illustrates a cross section of the direction in which the two electrode tabs 200 are led out.

The secondary battery 1000 of FIG. 13 is an example of a secondary battery according to an example embodiment, which includes two electrode assemblies 100 in a battery case 300 formed of a sheet having the same thickness as the battery case 300 of the secondary battery 1000 illustrated in FIG. 12, and in which the two electrode assemblies are isolated by disposing a partition wall 400 having a thickness of 215 μm (80 μm of the first and second sealing layers 410 and 420 of PP, 40 μm of the first metal layer 440 of Al, 15 μm of the inner resin layer 440 of nylon) between the two electrode assemblies 100.

In this manner, even if the thickness of the partition wall 400 is greater than the sheet of the battery case 300, there is no additional structure other than one partition wall 400 between the two electrode assemblies 100. Therefore, the thickness of the component that cannot store energy between the two electrode assemblies 100 is a total of 215 μm, which may reduce the thickness of the component that cannot store energy compared to the secondary battery 1000 of FIG. 12.

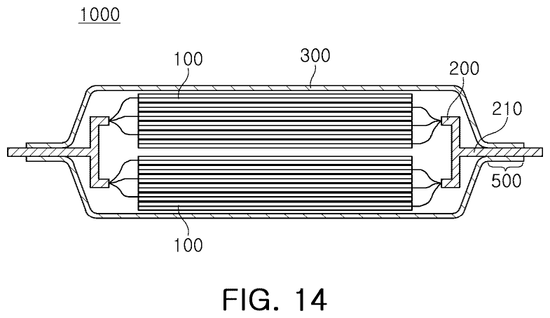

Meanwhile, FIG. 14 is a drawing schematically illustrating a secondary battery 1000 in which, for example, two electrode assemblies 100 are stored in a battery case 300 of one secondary battery 1000 without separate isolation and are connected by an electrical connection unit 210. FIG. 14 is a cross-sectional view illustrating a secondary battery 1000 in which the cathode and anode tabs 200 are respectively led out to both sides of the battery case 300, and illustrating the cross-section in the direction in which the two electrode tabs 200 are led out.

As illustrated in FIG. 14, the secondary battery 1000 does not have a partition wall 400 therein, and thus, does not have a thickness that cannot store energy between the two electrode assemblies 100, and thus, the energy density may be further increased.

However, as illustrated in FIG. 14, if the electrical connection between the two electrode assemblies 100 by the electrical connection unit 200 is a series connection, and a high voltage is generated inside the battery due to this, the high voltage may cause the electrolyte inside the battery case 300 to decompose, and may cause the lifespan of the battery to decrease.

As illustrated in FIG. 13, the secondary battery 1000 according to an example embodiment may generate a high voltage by electrically connecting a plurality of electrode assemblies 100 inside the battery case 300 in series. In the present disclosure, when connecting a plurality of electrode assemblies 100 inserted into a single battery case 300 in series, respect electrode tabs 200 may be led out from respective electrode assemblies to the outside of the battery case 300, and the electrode tabs 200 may be welded externally, or welded externally using a conductor, thereby electrically connecting the electrode tabs. For example, as illustrated in FIG. 13, when two electrode assemblies 100 are separated by a single partition wall 400 in the battery case 300, a first electrode assembly may be stored in a first storage space formed inside an upper case 350, and a second electrode assembly may be stored in a second storage space formed inside a lower case 360, and the first electrode assembly and the second electrode assembly may be electrically connected in series. The secondary battery 1000 according to an example embodiment may prevent the decomposition of the electrolyte due to high voltage by isolating respective electrode assemblies 100 by a partition wall.

When connecting the electrode assemblies 100 in series, the electrode tabs 200 are respectively led out in both directions from the electrode assemblies 100 located on both sides based on the partition wall 400. For example, as illustrated in FIG. 13, when two electrode assemblies 100 are isolated by one partition wall 400 in the battery case 300, the battery case 300, the electrode tabs 200, the partition wall 400, the electrode tabs 200, and the battery case 300 may be sequentially stacked in the sealing portion 500 of the area where the electrode tabs 200 are led out. Accordingly, the two electrode tabs 200 may be electrically connected outside the battery case 300. Alternatively, although not illustrated in the drawing, the two electrode tabs 200 may be electrically connected by an electrical connection unit 210 within the sealing portion 500 or at least a portion of the sealing portion 500 and may be led out of the battery case 300.

In the secondary battery 1000 according to an example embodiment, the thickness of a module or pack unit may be reduced by controlling the thickness of the partition wall 400, thereby increasing the energy density. Although not particularly limited, the thickness of the partition wall 400 (which may be referred to as T (partition)) may be smaller than the thickness of two battery cases 300, and in more detail, may be a thickness equal to or greater than the thickness of one battery case 300 (which may be referred to as T (battery case)) and less than the thickness of two battery cases 300, and in more detail, may be a thickness greater than the thickness of one battery case 300 and less than the thickness of two battery cases 300, and the thickness of the partition wall, T (partition), may satisfy the following expression (1).

T(battery case)<T(partition)<2×T(battery case) (1)

In each implementation example of the present disclosure, the electrode assembly accommodated in the storage space 370 of the battery case may be formed by repeatedly disposing a cathode, an anode and a separator according to example embodiments. In some embodiments, the electrode assembly may be a winding type, a stacking type, a zigzag folding type, or a stack-folding type.

The electrode assembly accommodated in the storage space may be a homogeneous electrode assembly, or may be used by mixing different types of electrode assemblies.

The cathode constituting the electrode assembly may include a cathode current collector and a cathode mixture layer disposed on at least one surface of the cathode current collector.

The cathode current collector may include stainless steel, nickel, aluminum, titanium, or alloys thereof. The cathode current collector may include aluminum or stainless steel surface-treated with carbon, nickel, titanium, or silver. The cathode current collector may be, for example, but not limited to, 10 to 50 μm.

The cathode mixture layer may include a cathode active material. The cathode active material may include a compound capable of reversibly intercalating and deintercalating lithium ions.

According to example embodiments, the cathode active material may include a lithium-nickel metal oxide. The lithium-nickel metal oxide may further include at least one of cobalt (Co), manganese (Mn), and aluminum (Al).

In some embodiments, the cathode active material or the lithium-nickel metal oxide may a layered structure or a crystal structure represented by the following chemical formula 1.

LiₓNiₐM_{b}O_{2+z} [Chemical Formula 1]

In chemical formula 1, 00.9≤x≤1.2, 0.6≤a≤0.99, 0.01≤b≤0.4, and −0.5≤z≤0.1 may be satisfied. As described above, M may include Co, Mn, and/or Al.

The chemical structure represented by chemical formula 1 represents a bonding relationship included in the layered structure or crystal structure of the cathode active material and does not exclude other additional elements. For example, M includes Co and/or Mn, and Co and/or Mn may serve as the main active element of the cathode active material together with Ni. Chemical formula 1 is provided to express the bonding relationship of the main active element and should be understood as a formula encompassing the introduction and substitution of additional elements.

In an embodiment, auxiliary elements may be further included in addition to the main active element to enhance the chemical stability of the cathode active material or the layered structure/crystal structure. The auxiliary elements may be incorporated into the layered structure/crystal structure to form a bond, and in this case, it should be understood that they are also included within the chemical structure range represented by Chemical Formula 1.

The auxiliary elements may include at least one of, for example, Na, Mg, Ca, Y, Ti, Hf, V, Nb, Ta, Cr, Mo, W, Fe, Cu, Ag, Zn, B, Al, Ga, C, Si, Sn, Sr, Ba, Ra, P or Zr. The auxiliary elements may also act as auxiliary active elements that contribute to the capacity/output activity of the cathode active material, such as Al, together with Co or Mn.

For example, the cathode active material or the lithium-nickel metal oxide may include a layered structure or a crystal structure represented by the following chemical formula 1-1.

LiₓNiₐM1_{b1}M2_{b2}O_{2+z} [Chemical formula 1-1]

In chemical formula 1-1, M1 may include Co, Mn, and/or Al. M2 may include the auxiliary element described above. In chemical formula 1-1, 0.9≤x≤1.2, 0.6≤a≤0.99, 0.01≤b1+b2≤0.4, and −0.5≤z≤0.1 may be satisfied.

The cathode active material may further include a coating element or a doping element. For example, elements substantially the same as or similar to the auxiliary elements described above may be used as the coating element or the doping element. For example, the elements described above may be used alone or in combination of two or more.

The coating element or doping element may be present on the surface of the lithium-nickel metal oxide particle, or may penetrate through the surface of the lithium-nickel metal composite oxide particle and be included in the bonding structure represented by chemical formula 1 or chemical formula 1-1.

The cathode active material may include a nickel-cobalt-manganese (NCM)-based lithium oxide. In this case, an NCM-based lithium oxide having an increased nickel content may be used.

Ni may be provided as a transition metal associated with the output and capacity of a lithium secondary battery. Therefore, as described above, by employing a high-content (High-Ni) composition in the cathode active material, a high-capacity cathode and a high-capacity secondary battery may be provided.

However, as the content of Ni increases, the long-term storage stability and life stability of the cathode or secondary battery may be relatively reduced, and side reactions with the electrolyte may also increase. However, according to example embodiments, by including Co, electrical conductivity may be maintained, and life stability and capacity retention characteristics may be improved through Mn.

The content of Ni (for example, the mole fraction of nickel among the total moles of nickel, cobalt, and manganese) in the NCM-based lithium oxide may be 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide-based active material, a lithium manganese oxide-based active material, a lithium nickel oxide-based active material, or a lithium iron phosphate (LFP)-based active material (for example, LiFePO₄).

In some embodiments, the cathode active material may include, for example, a Mn-rich active material, an LLO (Li rich layered oxide)/OLO (Over Lithiated Oxide) active material, or a Co-less active material having a chemical structure or crystal structure represented by Chemical Formula 2.

p[Li₂MnO₃]·(1−p)[Li_{q}JO₂] [Chemical Formula 2]

In Chemical Formula 2, 0<p<1, 0.9≤q≤1.2, and J may include at least one element among Mn, Ni, Co, Fe, Cr, V, Cu, Zn, Ti, Al, Mg, and B.

To manufacture the cathode, for example, the cathode active material may be mixed in a solvent to manufacture a cathode slurry. After coating the cathode slurry on the cathode current collector, drying and rolling may be performed to manufacture a cathode mixture layer. The coating process may be performed by a method such as gravure coating, slot die coating, multilayer simultaneous die coating, imprinting, doctor blade coating, dip coating, bar coating, casting, or the like, but is not limited thereto. The cathode mixture layer may further include a binder and optionally may further include a conductive agent, a thickener, or the like.

Non-limiting examples of solvents used in the manufacture of the cathode mixture include N-methyl-2-pyrrolidone (NMP), dimethylformamide, dimethylacetamide, N, N-dimethylaminopropylamine, ethylene oxide, tetrahydrofuran, and the like.

The binder may include polyvinylidenefluoride (PVDF), poly(vinylidene fluoride-co-hexafluoropropylene) copolymer, polyacrylonitrile, polymethylmethacrylate, acrylonitrile butadiene rubber (NBR), polybutadiene rubber (BR), styrene-butadiene rubber (SBR), etc. In an embodiment, a PVDF series binder may be used as the cathode binder.

The conductive material may be added to enhance the conductivity of the cathode mixture layer and/or the mobility of lithium ions or electrons. For example, the conductive material may include, but is not limited to, a carbon-based conductive material such as graphite, carbon black, acetylene black, Ketjen black, graphene, carbon nanotubes, vapor-grown carbon fiber (VGCF), carbon fiber, or the like, and/or a metal-based conductive material including perovskite materials such as tin, tin oxide, titanium oxide, LaSrCoO₃, or LaSrMnO₃.

If necessary, the cathode mixture may further include a thickener, a dispersant, and/or the like. In an embodiment, the cathode mixture may include a thickener such as carboxymethyl cellulose (CMC).

The anode constituting the electrode assembly may include an anode current collector and an anode mixture layer disposed on at least one surface of the anode current collector.

Non-limiting examples of the anode current collector include copper foil, nickel foil, stainless steel foil, titanium foil, nickel foam, copper foam, a polymer substrate coated with a conductive metal, and the like. The anode current collector is not limited thereto, but may be, for example, 10 to 50 μm.

The anode mixture layer may include an anode active material. A material capable of adsorbing and desorbing lithium ions may be used as the anode active material. For example, the anode active material may be a carbon-based material such as crystalline carbon, amorphous carbon, a carbon composite, or a carbon fiber; lithium metal; a lithium alloy; a silicon (Si)-containing material, a tin (Sn)-containing material, or the like.

Examples of the amorphous carbon may include hard carbon, soft carbon, coke, mesocarbon microbeads (MCMB), mesophase pitch-based carbon fiber (MPCF), and the like.

Examples of the crystalline carbon may include graphite-based carbon such as natural graphite, artificial graphite, graphitized coke, graphitized MCMB, and graphitized MPCF.

The lithium metal may be pure lithium metal or lithium metal having a protective layer formed thereon for suppressing dendrite growth, or the like. In an embodiment, a lithium metal-containing layer deposited or coated on an anode current collector may be used as an anode active material layer. In an embodiment, a lithium thin film layer may be used as an anode active material layer.

Elements included in the lithium alloy may include aluminum, zinc, bismuth, cadmium, antimony, silicon, lead, tin, gallium, indium, or the like.

The silicon-containing material may provide increased capacity characteristics. The silicon-containing material may include Si, SiOx (0<x<2), metal-doped SiOx (0<x<2), silicon-carbon composite, or the like. The metal may include lithium and/or magnesium, and the metal-doped SiOx (0<x<2) may include metal silicate.

To manufacture the anode, for example, the anode active material may be mixed in a solvent to manufacture an anode slurry. The anode slurry may be coated/deposited on an anode current collector, and then dried and rolled to manufacture an anode mixture layer. The coating process may be performed by a method such as gravure coating, slot die coating, multilayer simultaneous die coating, imprinting, doctor blade coating, dip coating, bar coating, casting, or the like, but is not limited thereto. The anode mixture layer may further include a binder and optionally may further include a conductive agent, a thickener, and the like.

In some embodiments, the anode may include an anode active material layer in the form of lithium metal formed through a deposition/coating process.

Non-limiting examples of the solvent for the anode mixture include water, pure water, deionized water, distilled water, ethanol, isopropanol, methanol, acetone, n-propanol, t-butanol, and the like.

The materials that may be used in the manufacture of the cathode may be used as the binder, conductive agent, and thickener.

In some embodiments, a styrene-butadiene rubber (SBR)-based binder, a carboxymethyl cellulose (CMC), a polyacrylic acid-based binder, a poly(3,4-ethylenedioxythiophene, PEDOT)-based binder, or the like may be used as the cathode binder.

A separator may be interposed between the cathode and the anode. The separator may be configured to prevent electrical short-circuiting between the cathode and the anode and to allow ion flow. According to an embodiment, the thickness of the separator may be 10 μm to 20 μm, but the present disclosure is not limited thereto.

For example, the separator may include a porous polymer film or a porous nonwoven fabric. The porous polymer film may include a polyolefin polymer such as an ethylene polymer, a propylene polymer, an ethylene/butene copolymer, an ethylene/hexene copolymer, and an ethylene/methacrylate copolymer. The porous nonwoven fabric may include a high-melting point glass fiber, a polyethylene terephthalate fiber, and the like. The separator may include a ceramic material. For example, inorganic particles may be coated on the polymer film or dispersed within the polymer film to improve heat resistance.

The separator may have a single-layer or multi-layer structure including the polymer film and/or nonwoven fabric.

An electrode assembly may be stored together with an electrolyte in a case to define a lithium secondary battery. According to example embodiments, a non-aqueous electrolyte may be used as the electrolyte.

The non-aqueous electrolyte contains a lithium salt as an electrolyte and an organic solvent, and the lithium salt is expressed as, for example, Li+X−, and as anion (X−) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, and the like may be used as an example.

The organic solvent may include an organic compound that has sufficient solubility for the lithium salt and the additive and does not have reactivity within the battery. For example, the organic solvent may include at least one of a carbonate solvent, an ester solvent, an ether solvent, a ketone solvent, an alcohol solvent, and an aprotic solvent. As examples of the organic solvents, for example, propylene carbonate (PC), ethylene carbonate (EC), butylene carbonate, diethyl carbonate (DEC), dimethyl carbonate (DMC), ethyl methyl carbonate (EMC), methylpropyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, Tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfur oxide, acetonitrile, dimethoxyethane, diethoxyethane, sulfolane, gamma-butyrolactone, propylene sulfite, and the like may be used. These may be used alone or in combination of two or more.

The non-aqueous electrolyte may further include an additive. The additives may include, for example, a cyclic carbonate compound, a fluorine-substituted carbonate compound, a sultone compound, a cyclic sulfate compound, a cyclic sulfite compound, a phosphate compound, and a borate compound.

The cyclic carbonate compound may include vinylene carbonate (VC), vinyl ethylene carbonate (VEC), and the like.

The fluorine-substituted cyclic carbonate compound may include fluoroethylene carbonate (FEC), and the like.

The sultone compound may include 1,3-propane sultone, 1,3-propene sultone, 1,4-butane sultone, and the like.

The cyclic sulfate compound may include 1,2-ethylene sulfate, 1,2-propylene sulfate, and the like.

The cyclic sulfite compound may include ethylene sulfite, butylene sulfite, and the like.

The phosphate compound may include lithium difluoro bis-oxalato phosphate, lithium difluoro phosphate, and the like.

The borate compound may include lithium bis(oxalate) borate, and the like.

As set forth above, a secondary battery according to an embodiment may implement high voltage.

According to another embodiment, a plurality of electrode assemblies may be included inside a battery case to reduce the thickness of the cell, thereby improving the energy density.

A secondary battery according to another embodiment may prevent decomposition of an electrolyte while implementing high voltage, thereby extending the battery life and providing battery safety.

The above-described contents are merely examples of applying the principles of the present disclosure, and other configurations may be further included without departing from the scope of the present disclosure.

Only specific examples of implementations of certain embodiments are described. Variations, improvements and enhancements of the disclosed embodiments and other embodiments may be made based on the disclosure of this patent document.

What is claimed is:

1. A lithium secondary battery comprising:
an electrode assembly accommodated inside a battery case,
wherein the battery case has two or more storage spaces separated by at least one partition wall, and each storage space accommodates at least one electrode assembly, and
the partition wall sequentially includes a first sealing layer, a first metal layer, and a second sealing layer.

2. The lithium secondary battery of claim 1, wherein the battery case includes an upper case and a lower case,
wherein the upper case and the lower case include an inner sealing layer, a second metal layer, and an outer resin layer.

3. The lithium secondary battery of claim 2, wherein the battery case has an inner sealing layer of the upper case and an inner sealing layer of the lower case, facing each other, and a partition wall interposed between the two inner sealing layers.

4. The lithium secondary battery of claim 1, wherein the battery case includes an upper case and a lower case,
the battery case includes a sealing portion to which the upper case and the lower case are attached on an edge of the battery case, and
the sealing portion includes at least three metal layers.

5. The lithium secondary battery of claim 4, wherein the sealing portion is provided on the same surface as a surface on which two adjacent electrode assemblies meet.

6. The lithium secondary battery of claim 4, wherein the sealing portion has a step from a surface on which two adjacent electrode assemblies meet.

7. The lithium secondary battery of claim 6, wherein the partition wall is formed to have a step between the sealing portion and the surface on which the two adjacent electrode assemblies meet.

8. The lithium secondary battery of claim 4, wherein the battery case includes the sealing portion on four sides.

9. The lithium secondary battery of claim 8, wherein the battery case is a single sheet in which the upper case and the lower case are connected, and includes a connecting sealing portion formed in a position in which the upper case and the lower case are connected.

10. The lithium secondary battery of claim 9, wherein the connecting sealing portion has a folding line folded at an end, and includes a margin between the folding line and the storage space.

11. The lithium secondary battery of claim 8, wherein the battery case is a separate sheet in which the upper case and the lower case are separated.

12. The lithium secondary battery of claim 4, wherein the battery case includes the sealing portion on three sides.

13. The lithium secondary battery of claim 12, wherein the battery case is a single sheet in which the upper case and the lower case are connected, and includes a connecting sealing portion formed in a position in which the upper case and the lower case are connected.

14. The lithium secondary battery of claim 1, wherein a thickness of the partition wall, T (partition), satisfies Expression (1): T (battery case)<T (partition)<2×T (battery case),
wherein in the expression (1), T (partition) is the thickness of the partition wall, and T (battery case) is a thickness of the battery case.

15. The lithium secondary battery of claim 1, wherein the first sealing layer and the second sealing layer are formed of a material selected from the group consisting of polypropylene (PP) and polyethylene (PE).

16. The lithium secondary battery of claim 1, wherein the first metal layer is formed of a material selected from the group consisting of aluminum (Al); copper (Cu); an alloy of iron (Fe), carbon (C), chromium (Cr), and manganese (Mn); an alloy of iron (Fe), carbon (C), chromium (Cr), and nickel (Ni); and an alloy including at least one of iron (Fe), carbon (C), chromium (Cr), manganese (Mn), copper (Cu) and nickel (Ni), and aluminum (Al).

17. The lithium secondary battery of claim 1, further comprising an inner resin layer on at least one surface of the first metal layer.

18. The lithium secondary battery of claim 17, wherein the inner resin layer is formed of a material selected from the group consisting of nylon, polyethylene, polypropylene, polyethylene terephthalate, low-density polyethylene, and high-density polyethylene.

19. The lithium secondary battery of claim 1, wherein a first electrode assembly stored in a first storage space separated by the partition wall and a second electrode assembly stored in a second storage space are electrically connected in series.
